(19) United States
(12) Patent Application Publication
(10) Pub. No.: US 2006/0109961 A1
(43) Pub. Date: May 25, 2006

(54) System and method for real-time medical department workflow optimization

(75) Inventors: Prakash Mahesh, Schaumburg, IL (US); Mark M. Morita, Arlington Heights, IL (US); Thomas A. Gentles, Algonquin, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 10/997,317

(22) Filed: Nov. 23, 2004

(51) Int. Cl. H04M 11/00

(52) U.S. Cl. 379/93.25

(57) ABSTRACT

Certain embodiments of the present invention provide a system and method for real-time workflow management in a healthcare environment. The system includes a database, an optimizer engine, and an interface. The database includes resource information for a healthcare environment. The optimizer engine is capable of communicating with the database to extract resource information. The interface is capable of communicating with the optimizer engine and a user. The interface is capable of allocating a resource to manage a workflow based on output from the optimizer engine. In an embodiment, the optimizer engine is capable of making a recommendation based on the resource information. In an embodiment, the interface presents the recommendation to the user, and may present the recommendation based on a rule, for example. In an embodiment, the interface may include a map of resources. The user may direct workflow based in part on the interface and/or the recommendation.

### BACKGROUND OF THE INVENTION

The present invention generally relates to a workflow management system. More specifically, the present invention relates to a system and method for real-time medical department workflow management.

Hospitals and other medical facilities, for example, imaging centers, continually seek to improve or optimize utilization of resources and productivity. Parameters such as patient wait times and procedure turn-around times may be used to measure such optimizations. Resources may include, for example, imaging rooms, nurses, patients, radiologists, cardiologists, and transcriptionists. For example, a patient that has an excessive waiting time may leave or become irritated, resulting in suboptimal resource utilization and/or productivity. In addition, if procedure turn-around times are not optimized, resources will be underutilized, resulting in reduced productivity because, for example, a resource such as an imaging room may sit idle when the imaging room could be used to provide services to another patient.

Many techniques are currently used to optimize parameters such as patient wait time and procedure turnaround time in a medical facility. For example, static reports may be created from medical information systems such as a Radiology Information System (RIS), Cardiovascular Information System (CVIS), Clinical Information System (CIS), Hospital Information System (HIS), Picture Archiving and Communication System (PACS), and/or other information or management system. Also, workflow rules may be created that provide for records and studies to be pre-fetched and for patient movements to be monitored. However, current systems and methods rely on multiple data sources. Information regarding resources must be compiled from different locations and systems. Such a process is time consuming and error prone and may be difficult to automate.

In addition, current system and methods are static in nature. In other words, these approaches do not take all of the details of a specific situation into account. Instead, these systems and methods define a fixed set of rules to be followed that attempts to improve performance in general or on average.

Another problem with current optimization systems and methods is that they are done after the fact. That is, reports are run on past data to aid in improving and/or optimizing future situations. Workflow rules are similarly developed. Such approaches do nothing to improve the care provided to current patients or enhance current productivity. Rather, benefits are realized only after another iteration of optimization.

Thus, a need exists for a system and method for real-time medical department workflow optimization. Such a system and method may provide automated and/or integrated access to resource information contained in one or more data sources. In addition, such a system allows improvements/optimizations to resource allocation to be made dynamically, in response to changing situations and accounting for the particulars of each situation. Further, such a system allows real-time improvement/optimization of workflow, so that utilization of resources is improved immediately, rather than only improving utilization for future cases.

### BRIEF SUMMARY OF THE INVENTION

Certain embodiments of the present invention provide a system and method for real-time workflow management in a healthcare environment. Certain embodiments of the system include a database, an optimizer engine, and an interface. The database includes resource information for a healthcare environment, such as a hospital or clinic. The optimizer engine is capable of communicating with the database to extract resource information. The interface is capable of communicating with the optimizer engine and a user. The interface is capable of allocating a resource to manage a workflow based on output from the optimizer engine. In an embodiment, the optimizer engine is capable of making a recommendation based on the resource information. In an embodiment, the interface presents the recommendation to the user, and may present the recommendation based on a filter and/or a rule, for example. In an embodiment, the interface may include a map of resources. In an embodiment, the database includes an interface to at least one medical information system. In an embodiment, the database is capable of accessing, controlling, and/or modifying a medical information system. In certain embodiments, the user directs the workflow based in part on the interface and/or the recommendation.

Certain embodiments of the present invention provide a real-time medical department workflow management interface system. The system includes a display device, an input device, and a user. The display device includes a map of resources. The input device is capable of communicating with the display device. The input device allows the user to allocate a resource in substantially real-time. In certain embodiments, the system also includes an optimizer engine. The optimizer engine is capable of communicating with the display device and/or the input device. The optimizer engine may generate a workflow allocation recommendation. The workflow allocation recommendation may be communicated to the user. In an embodiment, the display device prompts the user to respond to the workflow allocation recommendation. In certain embodiments, the user allocates the resource based in part on the map of resources and/or the workflow allocation recommendation.

Certain embodiments of the present invention provide a method for real-time medical department workflow management. The method includes reading resource information from a database, generating a resource map based in part on the resource information, displaying the resource map to a user, and directing workflow based in part on the resource map. In an embodiment, the method may also include determining a workflow allocation recommendation based in part on the resource information. In an embodiment, the method may also include presenting the workflow allocation recommendation to a user. In certain embodiments, the directing of workflow may be based in part on the workflow allocation recommendation.

Certain embodiments also provide a computer-readable storage medium including a set of instructions for a computer for use in a healthcare environment. The set of instructions includes an optimizer routine for resource allocation using resource information in a healthcare environment. The set of instructions also includes an interface routine for allocating one or more resources based on output from the optimizer engine. The interface routine is capable of accepting input from a user to assist in the allocation of one or more resources.

These and other features of the present invention are discussed or apparent in the following detailed description.

### BRIEF DESCRIPTION OF THE DRAWINGS

FIG. 1 illustrates a system for real-time medical department workflow management used in accordance with an embodiment of the present invention.

FIG. 2 illustrates a real-time medical department workflow management interface system used in accordance with an embodiment of the present invention.

FIG. 3 illustrates a flow diagram for a method for real-time medical department workflow management used in accordance with an embodiment of the present invention.

FIG. 4 illustrates a layout for a real-time medical department workflow management interface used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

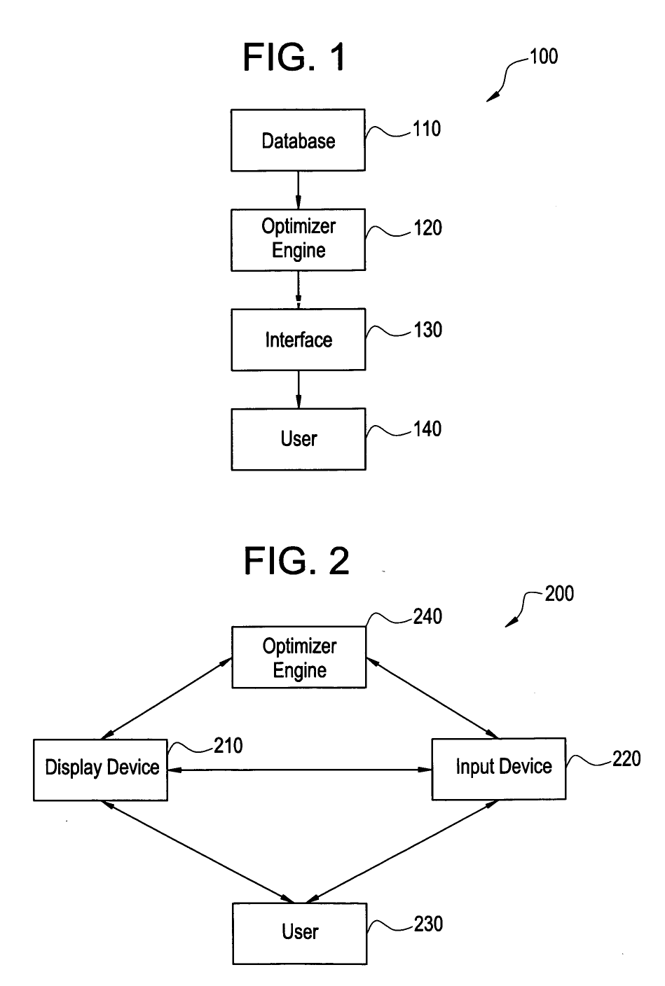

FIG. 1 illustrates a system 100 for real-time healthcare environment workflow management used in accordance with an embodiment of the present invention. The system 100 includes a database 110, an optimizer engine 120, an interface 130, and a user 140.

The database 110 is capable of communication with the optimizer engine 120. The optimizer engine 120 is capable of communication with the database 110. The optimizer engine 120 is capable of communication with the interface 130. The interface 130 is capable of communication with the optimizer engine 120. The interface 130 may further be capable of communication with the user 140. Communication may include wired and/or wireless communication, for example.

In operation, the database 110 contains resource information, for example. The database 110 may contain, for example, resource information for a full department, part of a department, and/or multiple departments within a healthcare environment or facility. A department may be, for example, a radiology, cardiology, surgery, oncology, emergency room, pediatrics, laboratory, and/or administrative department within a hospital, clinic, or medical facility. Resource information may include, for example, patient information, patient waiting time, transcriptionist capacity, transcriptionist capability, radiologist capacity, and/or radiologist capability. In this example, capacity is a number of available resources, and capability is a number of work elements the resource(s) may process in a given period of time. Alternatively, or in addition, resource information may include, for example, rooms, procedures, resource layouts, distances, metrics, nurses, computers, and/or modalities. For example, the database 110 may contain, in part, identification of room(s), such as waiting rooms and imaging rooms, room layout, room content, and/or distances and relationships between rooms. As another example, the database 110 may contain, in part, procedures that may be performed and/or metrics, such as average procedure time, average patient waiting time, and average patient recovery room time.

In an embodiment, the database 110 may be a collection of databases or other information repositories. The database 110 may act as a single interface to multiple information systems and other resources, for example. That is, the database 110 includes links or connections to other resource(s) to permit access and/or manipulation of the resource(s), for example. That is, the database 110 may enable access to multiple, disparate systems from a single interface, such as the interface 130. For example, the database 110 may include links, connections, and/or content with respect to a variety of medical information systems, such as RIS, CVIS, CIS, HIS, PACS, and/or other information or management system. In addition, the database 110 may include paging, electronic messaging, voice, and/or visual indicators, for example. The resources included in the database 110 may include information systems from multiple departments, for example.

In an embodiment, the database 110 may be accessed when information is needed by, for example, the optimizer engine 120 and/or the interface 130, in a “pull” model. In an embodiment, the database 110 may provide information to, for example, the optimizer engine 120 and/or the interface 130, in a “push” model when some changes are made to information in the database 110.

The database 110 may communicate some or all resource information to the optimizer engine 120 and/or the interface 130, for example. The optimizer engine 120 may communicate some or all of the resource information to the interface 130 and/or the database 110, for example. Resource information may also be communicated to an external system to facilitate clinical workflow and resource management, for example.

In an embodiment of the present invention, the optimizer engine 120 analyzes, for example, the resource information received from the database 110 to, for example, determine resource allocation recommendations. The resource allocation recommendations may, for example, suggest utilization of resources to achieve an optimization, increase, or improvement in resource usage. For example, the optimizer engine 120 may analyze resource information, such as patient waiting time, to generate a resource allocation recommendation regarding allocating patients to imaging resources to minimize patient waiting time. As another example, the optimizer engine 120 may analyze resource information, such as transcriptionist capacity and transcriptionist capability, to generate a resource allocation recommendation on how to allocate reports for transcription among transcriptionists to improve, or maximize, throughput. Allocation recommendations may be based on rules, priority levels, restrictions, filters, and/or other information provided to the engine 120, for example. The optimizer engine 120 may communicate the resource allocation recommendation to the interface 130 and/or to an external system, for example.

The interface 130 may communicate some or all of the resource information received from the optimizer engine 130 to the user 140. The interface 130 may include a display device. For example, the display device may be one or more of a computer screen, a portable computer, a tablet computer, and a personal digital assistant (PDA). The interface 130 may include an input device. For example, the input device may include one or more of a keyboard, a touchscreen, a joystick, a mouse, a touchpad, and a microphone. The input device may use a microphone in conjunction with voice recognition software and/or hardware, for example.

In an embodiment, the interface 130 communicates at least part of the resource information to the user 140 by a resource map. The resource map is a graphical representation of the resources that are used in a medical department workflow, for example. The resource map may include a map, layout, and/or representation of the resources of one or more departments within a hospital, for example. The resource map may, for example, include a depiction of a physical or logical layout of resources within the department. Department resources may include imaging facilities, waiting room, patient, patient waiting times, and/or transcriptionists, for example. In an embodiment, the resource map may show trends in resource usage. For example, the resource map may indicate a throughput of imaging rooms over a time period, such as a month. In an embodiment, the resource map may be a database or other data structure including a list of resources and availability of the resources, for example.

In an embodiment, the resource information conveyed to the user 140 by the interface 130 may be selected using filter(s) and/or rule(s), for example. For example, a user may be concerned with resource information specific to a radiology department. For example, the user 140 may communicate to the interface 130 indicating a certain filter is to be used to specify a subset of resource information to be displayed on a resource map. The user 140 may, for example, select an icon on the interface 130 limiting the resource map to displaying only patients with waiting times greater than 30 minutes. As another example, a user may define rule(s) to format the resource information displayed to the user 140.

In an embodiment, more detailed resource information may be provided on demand. That is, the interface 130 may convey resource information to the user 140 that is selected using a set of rules. For example, the interface 130 may convey information regarding all waiting patients. The user 140 may then desire more specific and/or detailed resource information regarding a subset of the resource information conveyed and the user 140 may request such information from the interface 130. For example, the user 140 may desire resource information such as the name and pending procedure of a specific patient and request the name and pending procedure for that patient from the interface 130. As another example, the interface 130 may convey to the user 140 a map of departments within a hospital. The user 140 may then request additional resource information regarding a specific department, such as the radiology department.

In an embodiment, the interface 130 may communicate resource information based on predetermined and/or configurable rules. For example, the interface 130 may be configured to communicate patient waiting time information in a color-coded manner, such as, patients waiting longer than 30 minutes are indicated in red. Some user(s) 140 may have interest in different pieces of resource information and may configure the interface 130 to display that information only. For example, a user 140 interested in minimizing patient waiting time may configure the interface 130 to color code patient resources based on waiting time, whereas a user 140 interested in maximizing procedure throughput may prefer patients to be colored according to estimated procedure time, as well as having the current rooms and capabilities displayed.

In an embodiment of the present invention, the interface 130 may communicate the recommendation received from the optimizer engine 120 to the user 140. The interface 130 may display a pop-up window or overlay, email or page the user 140, and/or generate a printed, displayed and/or transmitted report, for example.

In an embodiment, the interface 130 may be a “dashboard.” The dashboard may be a hardware device, software application, or combination of hardware and software. The dashboard may convey resource information to the user 140. For example, the dashboard may convey to the user the available resources and the current, or potential, allocation of those resources. The dashboard may convey resource information in part using a resource map.

The user 140 may direct workflow and/or allocate resources based in part on resource information received from the interface 130. The user 140 may use resource information communicated by the interface 130 to, for example, optimize procedure turn-around time and/or minimize patient waiting time.

In an embodiment, the allocation of resources by the user 140 occurs in real-time, or substantially real-time. That is, when the user 140 communicates a resource allocation using the interface 130, the allocation occurs in immediately or after some delayed period of time due in part to system delay, processing delay, communication lag, and/or time need by the user to confirm the allocation, for example.

In an embodiment, the user 140 may direct workflow and/or allocate resources based in part on the recommendation from the optimizer engine 120, as received from the interface 130. The user 140 may direct workflow and/or allocate resources manually and/or using software and/or hardware, for example. The user 140 may direct workflow and/or allocate resources by assigning resources, such as imaging equipment, to certain tasks, and/or assigning personnel, such as radiologist, to certain tasks. In an embodiment, when the user 140 directs workflow by, for example, allocating resources, systems related to those resources may be notified, modified, and/or updated automatically. For example, if a user 140 allocates a file to be transcribed from one transcriptionist to another, the work-list for each transcriptionist, which may be maintained in a separate system, may be automatically updated.

In an embodiment, the user 140 may be, for example, a supervisor or member of a hospital administration staff. In certain embodiments, one kind of user may have different access and modification capabilities than another user. For example, a staff member may only be permitted to access some kinds of resource information from the interface 130, while a supervisor may have access to all of the resource information and be able to allocate resources.

In an embodiment, the user 140 may be a combination of one or more of a software program, a software process, and a hardware device. The user 140 may automatically monitor resource information conveyed by the interface 130. The user 140 may automatically allocate resources to improve or optimize resource utilization and/or workflow. For example, the user 140 may be a software application that utilizes a heuristic or set of rule(s) to balance the distribution of files to be transcribed among available transcriptionists.

FIG. 2 illustrates a real-time healthcare environment management interface system 200 used in accordance with an embodiment of the present invention. The system 200 includes a display device 210, an input device 220, and a user 230. In an embodiment of the present invention, the system 200 also includes an optimizer engine 240.

The display device 210 may be capable of communication with one or more of the input device 220, the user 230, and the optimizer engine 240. The input device 220 may be capable of communication with one or more of the display device 210, the user 230, and the optimizer engine 240. The user 230 may be capable of communication with the display device 210 and/or the input device 220. The optimizer engine 240 may be capable of communication with the display device 210 and/or the input device 220.

In operation, the display device 210 includes a map of resources. In an embodiment, the display device 210 may be similar to the display device component of the interface 130, described above. The map of resources is communicated to the user 230. For example, the display device 210 shows the map of resources on a computer screen or PDA screen.

The input device 220 allows the user 230 to allocate resources, for example. In an embodiment, the input device 220 may be similar to the input device component of the interface 130, described above. The user 230 may communicate an allocation of resources using the input device 220. The user 230 may allocate resources using the input device 220 based in part on the map of resources communicated to the user 230 from the display device 210. For example, the user 230 may designate that a patient is to be assigned to a specific imaging room by using a mouse to drag-and-drop the patient resource symbol onto the imaging room symbol. The allocation of resources may be communicated from the input device 220 to the optimizer engine 240. Resources may be allocated by paging, electronic messaging, visual signal, updating indicators in a database, and/or communication with an external system, for example. For example, the allocation of a file to be transcribed from a pool to a specific transcriptionist may move the file into the appropriate location and update the work list for the transcriptionist to include the new file to be transcribed. Allocation of a physician to an examination room may be indicated on a chart or status board, for example.

In an embodiment, the allocation of resources by the user 230 occurs in real-time, or substantially real-time. That is, when the user 230 communicates a resource allocation using the input device 220, the allocation occurs immediately or after some delayed period of time due in part to system delay, processing delay, communication lag, and/or time need by the user to confirm the allocation, for example.

In an embodiment of the present invention, the display device 210 and the input device 220 may be part of a single hardware device and/or software application. For example, the display device may be a tablet computer (display device 210) with a touchscreen (input device 220).

In an embodiment, the optimizer engine 240 may generate a workflow allocation recommendation. The optimizer engine 240 may be similar to the optimizer engine 120, described above, for example. The optimizer engine 240 may, for example, analyze a current allocation of resources and, based on algorithms or heuristics, may determine a preferred or improved allocation. Based in part on the allocation determination, the optimizer engine 240 may generate a workflow allocation recommendation and communicate that recommendation to the display device 210.

The display device 210 communicates a workflow allocation recommendation to the user 230. The display device 210 may prompt the user 230 to respond to a workflow allocation recommendation. The user 230 may use the input device 220 to respond to the workflow allocation recommendation. The response of the user 230 may then cause resources to be allocated based in part on the workflow allocation recommendation. In an embodiment, the user 230 may be similar to the user 140, described above.

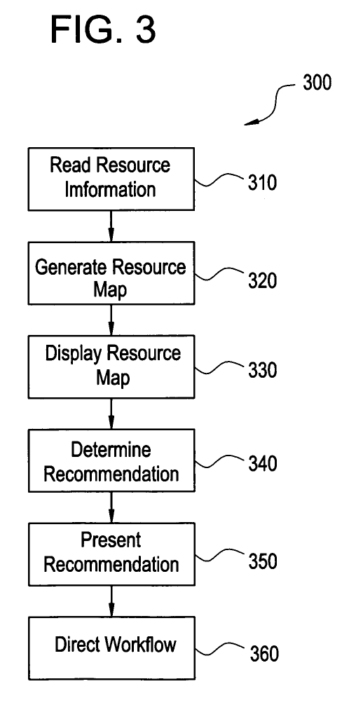

FIG. 3 illustrates a flow diagram for a method 300 for real-time medical workflow management used in accordance with an embodiment of the present invention. The method 300 includes the following steps, which will be described in more detail below. First, at step 310, resource information is read. Next, at step 320, a resource map is generated. At step 330, a resource map is displayed. Then, at step 340, a recommendation is determined. Next, at step 350, a recommendation is presented. At step 360, workflow is directed. Certain embodiments of the present invention may omit one or more of these steps and/or perform the steps in a different order than the order listed, including simultaneously.

First, at step 310, resource information is read. For example, resource information may be read from a database, data store, and/or other information source. Resource information may include, for example, patient information, patient waiting time, transcriptionist capacity, transcriptionist capability, radiologist capacity, radiologist capability, physician availability, nurse availability, examination resources, imaging resource, and/or other resource information. Alternatively, or in addition, resource information may include, for example, rooms, procedures, resource layouts, distances, metrics, nurses, physicians, computers, and/or modalities. For example, resource information may be read from a database or data store(s) similar to the database 110, described above. Resource information may be read from multiple information systems and other resources. For example, resource information may be read from a variety of medical information systems and/or departments such as RIS, CVIS, CIS, HIS, PACS, radiology, cardiology, emergency room, laboratory, administration, and/or other information or management system or healthcare environment.

In an embodiment, the database 110 may be accessed when information is needed from, for example, the optimizer engine 120, in a “pull” model. In an embodiment, the database 110 may provide information to, for example, the optimizer engine 120, in a “push” model when some changes are made to information in the database 110.

Next, at step 320, a resource map is generated. The resource map may be generated based in part on the resource information read in step 310. The resource map may include a map, layout, depiction, and/or description of resource information, for example. For example, the resource map may include a representation of imaging rooms in a hospital, illustrating their spatial relationship, current utilization, capacity, and/or capabilities. As another example, the resource map may list a pool of files to be transcribed, the files assigned to each transcriptionist, and/or the capabilities of each transcriptionist. As another example, the resource map may be a chart of patients and physicians and/or nurses assigned to examine the patients. In an embodiment, the resource map generated may be similar to the resource map communicated by the interface 130 to the user 140, described above.

At step 330, a resource map is displayed. The resource map to be displayed may be, for example, a resource map similar to the one generated in step 320. The resource map may be displayed on an interface similar to the interface 130, described above. The resource map may be displayed on a display device similar to the display device 210, described above. The resource map may be communicated to a user, such as a user 140, 230, as described above.

Then, at step 340, a recommendation is determined. A workflow allocation recommendation may be determined based in part on resource information, such as the resource information read in step 310. A workflow allocation recommendation may be determined using rules and/or preferences set by a user, group of users, department, administration, and/or program, for example. The workflow allocation recommendation may describe an improved and/or optimized workflow and/or resource allocation, for example. In an embodiment, the workflow allocation recommendation is made by an optimizer engine. In an embodiment, the optimizer engine may be similar to the optimizer engine 120 or 240, described above.

Next, at step 350, a recommendation is presented. A workflow allocation recommendation may be presented to, for example, a user, such as the user 140, 230. The workflow allocation recommendation presented may be based on the workflow allocation recommendation determined in step 340. The workflow allocation recommendation may be presented by a computer display, a printed report, a voice message, and/or an electronic message, for example. The workflow allocation recommendation may be presented by an interface similar to interface 130. The workflow allocation recommendation may be presented by a display device similar to display device 210.

At step 360, workflow is directed. Workflow may be directed by, for example, a user, such as a user 140, 230. For example, workflow may be directed by the allocation of resources. Workflow may be directed based in part on a resource map, such as the one displayed in step 330. Workflow may be directed based in part on a recommendation, such as the one presented in step 350. Workflow may be directed by paging, electronic messaging, visual signal, updating indicators in a database, and/or communication with an external system, for example. In an embodiment, the direction of workflow occurs in real-time, or substantially real-time. That is, the direction of workflow and/or allocation of resources occurs immediately or after some delayed period of time due in part to system delay, processing delay, communication lag, and/or time need by the user to confirm the allocation, for example.

For example, available resources may include a radiology waiting room and a number of patients. Resource information may include waiting times for the patients and a number of patients in the radiology waiting room. Resources and resource information may be retrieved from a RIS, for example. Rules used to generate resource allocation recommendations may include rules corresponding to a number of patients, for example. For example, if 0-10 patients are waiting in the radiology waiting room, an alert indicator is green. If 11-20 patients are waiting in the radiology waiting room, the alert indicator is yellow. If 21 or more patients are waiting in the radiology waiting room, the alert indicator is red. Another rule, for example, may relate to patient waiting times. For example, if a patient has been waiting 0-10 minutes, an alert indicator is green. If a patient has been waiting 11-20 minutes, the alert indicator is yellow. If a patient has been waiting 21 minutes or longer, the alert indicator is red. The resource map that is part of the dashboard interface displays a representation of the radiology waiting room and dynamically updates the resource map at a certain interval (e.g., anywhere from real-time or substantially real-time to every two minutes, every five minutes, every thirty minutes, etc.).

When patients arrive at the front desk, demographic and schedule information for the patients are verified. The patients are marked as arrived in the RIS. At this point, the resource map and dashboard display a green icon for each newly-arrived patient. The resource map and dashboard keep track of how many patients are in the room and how long each patient has been waiting, for example. When a patient has waited for more than ten minutes, the dashboard turns the patient's icon yellow. When a patient has waited for more than twenty minutes, the patient's icon turns red. If the number of patients in the room exceeds the limit allowed by the rules, the entire room color changes appropriately (e.g., yellow, red, etc.). The visual indicators alert administrator(s) and/or the optimization engine to take appropriate action and/or generate resource allocation recommendation(s). For example, if more than fifteen patients are waiting in the radiology waiting room, the system may allocate additional resources, such as technologist and examination room, to radiology. If a patient has been waiting for more than fifteen minutes, an administrator or staff may be prompted to talk to the patient and provide the patient with a status update, and/or the system may increase the patient's priority in a waiting queue, for example.

As mentioned above, certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

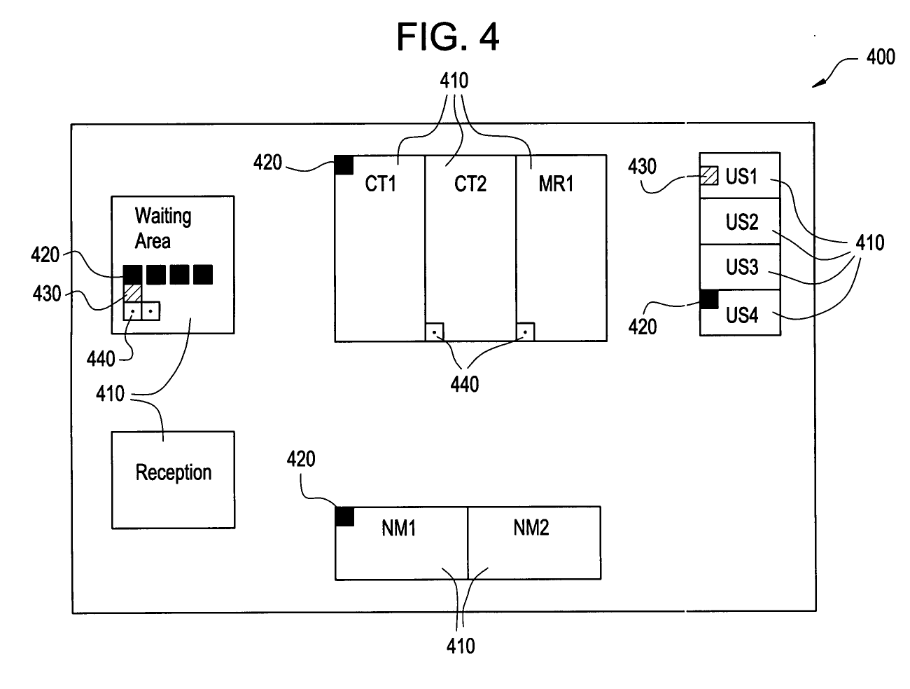

FIG. 4 illustrates a layout 400 for a real-time healthcare environment workflow management interface (e.g. a dashboard with a resource map) used in accordance with an embodiment of the present invention. The layout 400 includes resources. Resources may include, for example, facilities 410. Facilities 410 may include, for example, reception, waiting areas, and imaging rooms. Imaging rooms may include ultrasound, CT scanning, x-ray, MRI, and nuclear medicine, for example.

Resources may also include, for example, patients 420, 430, 440. Patients may be categorized by waiting time. Categories may include, for example, patients having a waiting time of fifteen minutes or less 420, patients having a waiting time between fifteen minutes and thirty minutes 430, and patient having a waiting time of thirty minutes or more 440. In an embodiment, patients with different waiting time categories may be represented in different colors. For example, patients having a waiting time of thirty minutes or more may be displayed in red, whereas patients having a waiting time of fifteen minutes or less may be displayed in green.

A resource map communicated by interface 130, described above, may utilize a layout similar to layout 400. A resource map generated at step 320 and/or presented at step 330 may utilize a layout similar to layout 400. A dashboard, as described above, may utilize a layout similar to layout 400.

Thus, certain embodiments of the present invention provide a simplified interface to multiple data sources. Certain embodiments also allow dynamic optimization of workflow and workload. Certain embodiments of the present invention allow real-time optimization of medical department workflow to provide immediate benefits to current patients, resource utilization, and productivity.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A real-time medical workflow management system, said system including:
a database including resource information for a healthcare environment;
an optimizer engine capable of communication with said database to extract said resource information; and
an interface capable of communication with said optimizer engine, wherein said interface is capable of allocating a resource to manage a workflow based on output from said optimizer engine.

2. The system of claim 1, wherein said optimizer engine is capable of making a recommendation based on said resource information.

3. The system of claim 2, wherein said interface presents said recommendation to a user.

4. The system of claim 1, wherein said interface displays said resource information based in part on a rule.

5. The system of claim 1, wherein said interface includes a map of resources.

6. The system of claim 1, wherein said database includes an interface to at least one medical information system.

7. The system of claim 1, wherein said database is capable of at least one of accessing, controlling, and modifying a medical information system.

8. The system of claim 1, wherein said user directs said workflow based in part on said interface.

9. The system of claim 4, wherein said user directs said workflow based in part on said recommendation.

10. A real-time medical department workflow management interface system, said system including:
a display device, said display device including a map of resources; and
an input device, said input device capable of communicating with said display device, said input device allowing a user to allocate a resource in substantially real-time.

11. The system of claim 10, further including an optimizer engine, said optimizer engine capable of communicating with at least one of said display device and said input device.

12. The system of claim 11, wherein said optimizer engine generates a workflow allocation recommendation.

13. The system of claim 12, wherein said workflow allocation recommendation is communicated to said user.

14. The system of claim 13, wherein said display device prompts said user to respond to said workflow allocation recommendation.

15. The system of claim 10, wherein said user allocates said resource based in part on said map of resources.

16. The system of claim 13, wherein said user allocates said resource based in part on said workflow allocation recommendation.

17. A method for real-time workflow management in a healthcare environment, said method including:
reading resource information from a database;
generating a resource map based in part on said resource information;
displaying said resource map to a user; and
directing workflow based in part on said resource map.

18. The method of claim 17, further comprising determining a workflow allocation recommendation based in part on said resource information.

19. The method of claim 18, further comprising presenting said workflow allocation recommendation to a user.

20. The method of claim 19, wherein said directing workflow further comprises directing workflow based in part on said workflow allocation recommendation.

21. A computer-readable storage medium including a set of instructions for a computer, the set of instructions comprising:
an optimizer routine for resource allocation using resource information in a healthcare environment; and
an interface routine for allocating one or more resources based on output from said optimizer engine, said interface routine capable of accepting input from a user to assist in said allocation of one or more resources.
